(19) United States
(12) Patent Application Publication
(10) Pub. No.: US 2014/0167805 A1
(43) Pub. Date: Jun. 19, 2014

(54) REDUCED FOOTPRINT TEST SOCKET SYSTEM

(71) Applicants: Michael K. Dell, Campbell, CA (US); Lynwood Adams, Rockwall, TX (US)

(72) Inventors: Michael K. Dell, Campbell, CA (US); Lynwood Adams, Rockwall, TX (US)

(21) Appl. No.: 14/012,175

(22) Filed: Aug. 28, 2013

Related U.S. Application Data
(60) Provisional application No. 61/694,399, filed on Aug. 29, 2012.

(51) Int. Cl. H01R 13/62

(52) U.S. Cl. CPC H01R 13/62
USPC 324/756.02

(57) ABSTRACT

A test socket system has a housing with a screw that extends through central openings in the housing and a pusher block. Positioned below the pusher block is an integrated circuit and positioned below the integrated circuit is a contact set. The contact set is slidably received within slots on the inner surface of side walls of the housing. Positioned below the contact set is a PC adapter which is connected to a motherboard. The PC adapter has holes that receive dowels that extend downwardly from the bottom edge of the side walls of the housing. This system allows for easy and quick attachment of integrated circuits to a motherboard for testing purposes.

### BACKGROUND OF THE INVENTION

This invention is related to a test socket system and more particularly a test socket system that does not require mounting features on the motherboard.

Test sockets are well-known in the art and are used to make an electro-mechanical connection between a packaged integrated circuit (IC) and a printed circuit board (PCB) for testing the functionality and/or performance of the IC. Typically, the test socket employs different electrical interconnect systems such as spring loaded pins, ridged metal contacts, conductive elastomers and other structures that pass current and electrical signals between terminals on the IC and PCB. The test socket normally has mounting holes with screws and alignment pins that mate with corresponding holes in the PCB.

When a PCB is designed for end use as a motherboard, test sockets are not used and the IC is directly attached to the board, usually by soldering. There are situations where an end user wishes to test one or more devices on the board without having the device under test (DUT) soldered. In these, and other situations, a test socket that does not require mounting features is desired. In addition, due to space constraint on the PCB, additional active and passive components are near the DUT and must be accommodated.

Therefore, an objective of the invention is to provide a test socket system that does not require mounting features on the motherboard.

A further objective of the invention is to provide a test socket system that accommodates passive components near active components.

Yet another object of the invention is to provide a test socket system that is inexpensive.

Another object of the invention is to provide a test socket system that is fast and easy to use.

Yet another object of the invention is to provide a test socket system that compensates for variation of the coplanarity between the DUT/IC and the motherboard.

Another object of the invention is to provide a test socket system that has a zero footprint.

These and other objectives will be apparent to one of ordinary skill in the art based upon the following written description.

### SUMMARY OF THE INVENTION

A test socket system has a housing with a screw that extends through central openings in the housing and a pusher block. Positioned below the pusher block is an integrated circuit and positioned below the integrated circuit is a contact set. The contact set is slidably received within slots on the inner surface of side walls of the housing.

Positioned below the contact set is a PCB adapter which is connected to a motherboard. The PC adapter has holes that receive dowels that extend downwardly from the bottom edge of the side walls of the housing. This system allows for easy and quick attachment of integrated circuits to a motherboard for testing purposes.

### BRIEF DESCRIPTION OF THE DRAWINGS

FIG. 1 is an exploded perspective view of a test socket system;

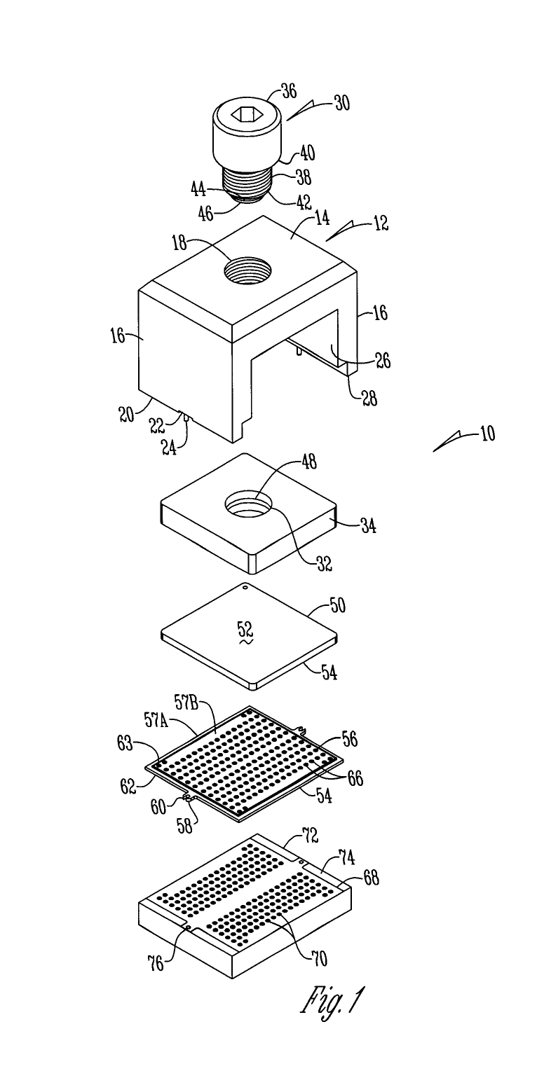

FIG. 2 is an exploded perspective view of a test socket system; and

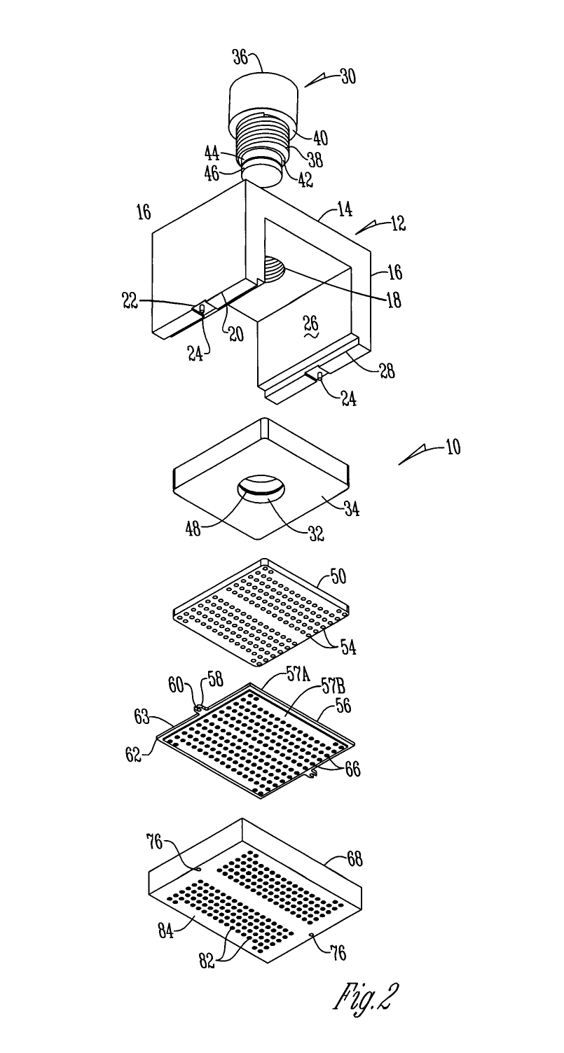

FIG. 3 is a perspective view of a test socket system attached to a motherboard.

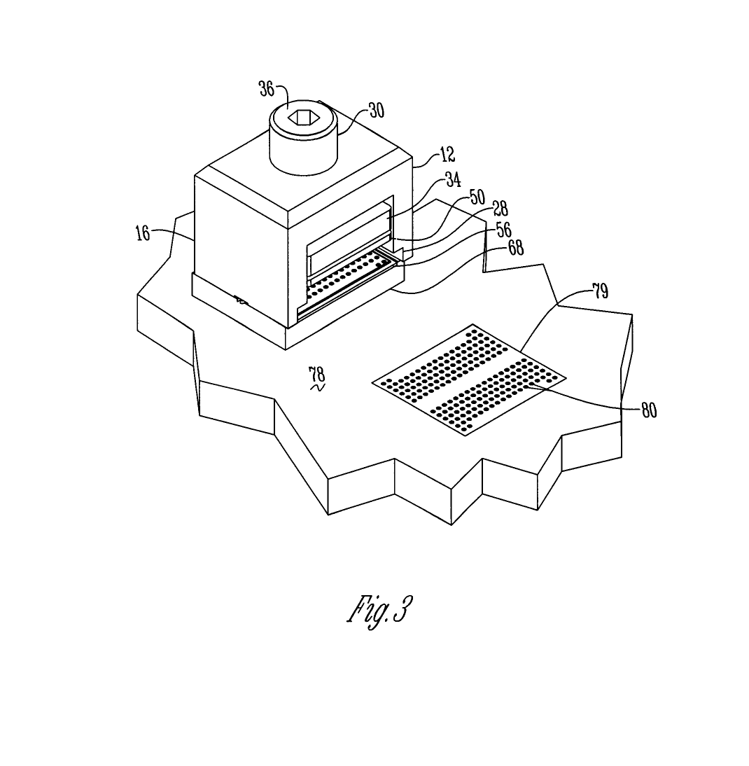

### DETAILED DESCRIPTION OF THE PREFERRED EMBODIMENTS

Referring to the Figures, the test socket system 10 includes a housing 12 having a top wall 14 and multiple side walls 16 that extend downwardly from the top wall 14. In the arrangement shown, a pair of opposing side walls 16 are shown, however any number of side walls 16 are contemplated such as 3, 4, 5, 6, or more. The top wall 14 has a centrally located opening 18. Along the bottom edge 20 of the side walls 16 is a cut-out section 22 from which one or multiple dowels 24 extend in a downward direction. Adjacent the bottom edge 20, extending lengthwise along the interior of the inner surface 26 of the side walls 16 are slots 28. Slots 28 may be grooves, recesses, or any other alignment feature positioned on or in or connected to the interior of inner surface 26 and can extend any distance up the inner surface 26 to provide alignment for the other components of the system 10 as is discussed herein.

A screw 30 is formed to extend through opening 18. In one example, screw 30 is a pusher screw received in a central opening 32 of a pusher block 34, by a snap fit connection. Alternatively, screw 30 threadably engages opening 18. In one arrangement, the screw 30 has a head 36 with a shaft 38 having a diameter smaller than the head 36 to form a shoulder 40. Extending from the shaft 38 and having a diameter smaller than the diameter of shaft 38 to form shoulder 42 is a connecting extension 44. The connecting extension 44 has a ridge 46 that extends around the outer surface of the extension 44 which is formed to be received in a groove 48 which extends around the wall of opening 32. The description of pusher screw 30 is not meant to be limiting. Any other type of screw is hereby contemplated such as a straight screw, a shoulder screw, a stepped screw, a tapered screw, a bolt screw or the like or any other type of connecting member may be used, such as a snap fit arrangement, a press arrangement or the like to connect pusher screw 30 to pusher block 34.

The pusher block 34 has a width that fits within side walls 16 and a length no greater than the length of top wall 14. In this arrangement, pusher block 34 fits within and is aligned by sidewalls 16 and is vertically positional by rotating pusher screw 30.

Positioned below the pusher block 34 is a packaged integrated circuit (PIC) device under test (DUT) 50 (DUT for short). In one arrangement, the DUT 50 is smooth on the top surface 52 and has downwardly extending leads 54. In one arrangement, the downwardly extending leads 54 are merely electrical contact points which are flush with a generally flat and planar bottom surface of the DUT 50. In another arrangement, the downwardly extending leads 54 protrude a distance from the flat and planar bottom surface of the DUT 50. In one arrangement, the downwardly extending leads 54 take on the form of a ball grid array (BGA).

A ball grid array (BGA) is a type of surface-mount packaging used for integrated circuits. BGA packages are used to permanently mount devices, such as microprocessors, to other components, such as motherboards. A BGA can provide more interconnection pins than can be put on a dual in-line or flat package. The whole bottom surface of the device can be used, instead of just the perimeter. The leads are also on average shorter than with a perimeter-only type, leading to better performance at high speeds.

The BGA is descended from the pin grid array (PGA), which is a package with one face covered (or partly covered) with pins in a grid pattern which, in operation, conduct electrical signals between the integrated circuit and the motherboard or printed circuit board (PCB) on which it is placed. In a BGA the pins are replaced by pads on the bottom of the package, each initially with a tiny ball of solder stuck to it. These solder spheres can be placed manually or by automated equipment, and are held in place with a tacky flux. [1] The device is placed on a PCB with copper pads in a pattern that matches the solder balls. The assembly is then heated, either in a reflow oven or by an infrared heater, melting the balls. Surface tension causes the molten solder to hold the package in alignment with the circuit board, at the correct separation distance, while the solder cools and solidifies, forming soldered connections between the device and the PCB.

BGA is a solution to the problem of producing a miniature package for an integrated circuit with many hundreds of pins. Pin grid arrays and dual-in-line surface mount packages were being produced with more and more pins, and with decreasing spacing between the pins, but this was causing difficulties for the soldering process. As package pins got closer together, the danger of accidentally bridging adjacent pins with solder grew. BGAs resolve many of these problems.

Like the pusher block 34, the DUT 50 is sized and shaped to fit within and is aligned by sidewalls 16 of housing 12. Or, said another way, the size, shape and dimensions of the housing 12 are designed such that the housing 12 fits over the DUT 50 within close tolerances such that the housing 12 holds and aligns the DUT 50. Like pusher block 34, the DUT 50 and is vertically positional within the housing 12 by rotating pusher screw 30.

Positioned below the IC 50 is contact set 56. Contact set 56 serves to connect the downwardly extending leads 54 of the DUT 50 to the leads electrical interconnects 70 on the PCB adapter 68. In one arrangement, contact set 56 is formed of a plurality of spring pins.

In another arrangement, contact set 56 includes a frame 57A which holds and surrounds a flexible member 57B. In one arrangement frame 57A is a rigid or semi-rigid member which provides support for and holds the flexible member 57B so as to maintain its dimensional size and shape within needed tolerances.

In one arrangement, flexible member 57B is an elastomeric interconnect. In this arrangement, the elastomeric interconnect of flexible member 57B is formed of a sheet of flexible and compressible silicon rubber which is non-conductive in nature, or said another way, is an electrical insulator. Any other flexible and/or compressible material is hereby contemplated for use. The elastomeric interconnect of flexible member 57B has a plurality of electrical interconnects 66 therein that align with the leads 54 of the DUT 50 and receive leads 54 of the DUT 50 on its top surface. In one arrangement, these electrical interconnects 66 are formed of columns of particles of electrically conductive material suspended within the elastomeric interconnect, or silicon rubber. In one arrangement, these columns of conductive material extend from the top surface to the bottom surface of the flexible member 57B so as to provide an electrical passageway through the insulating elastomeric interconnect or flexible member 57B.

The electrically conductive material can include any conductive material such as copper, silver, gold, iron, metal, alloy, aluminum, any alloy or any combination thereof or the like. In one arrangement gold powder, gold particles, gold coated particles, gold dust or gold beads are suspended in columns within the silicon rubber. In one arrangement, when not compressed, these columns of conductive material are not-conductive or non-conductive; in contrast, when compressed, these columns of conductive material are conductive.

Connected to the exterior edge of frame 57A are one or multiple tabs 58 which include slots 60 which are in vertical alignment with dowels 24 of the housing 12. The tabs 58 permit installation and/or replacement as well as alignment of the contact set 56 with housing 12, pusher block 34 and DUT 50 after assembly. In one arrangement, the bottom edge 62 and/or the top edge 63 of frame 57A of the contact set 56 extends upwardly and/or downwardly thereby providing a shoulder, step, recess or protrusion at the intersection of frame 57A and flexible member 57B that aids in aligning the contact set 56 with the other components described herein such as DUT 50. In another arrangement, the frame 57A is vertically narrower or thinner than the flexible member 57B, such that the frame does not prevent compression of the flexible member between the DUT 50 and the printed circuit board adapter 68. The exterior edge of frame 57A is sized and shaped to be held by and slidably received within slots 28 on the inner surface 26 of the housing 12 when the dowels 24 are received within slots 60 of tabs 58.

Positioned below the contact set 56 is a printed circuit board adapter 68 (PCB adapter). The PCB adapter 68 has a plurality of electrical interconnects 70, also known as pads, that align with leads 54 of the DUT 50 and/or electrical interconnects 66 of the contact set 56. The PCB adapter 68 also has elongated top edges 72 that extend along the top surface of the sides of the PCB adapter 68. The top edges 72 include multiple mounting surfaces 74 and at least one if not multiple openings 76 that align with and receive dowels 24 from the housing 12. When fully assembled, the mounting surfaces 74 abut the bottom edge 20 of the side walls 16 of housing 12.

In one arrangement electrical interconnects 70 of PC adapter 68 extend through the PC adapter 68 and therefore are exposed at the top surface and the bottom surface of PC adapter 68

The PCB adapter 68 is connected to a motherboard or system board 78. The motherboard 78 has a footprint 79 thereon which is sized and shaped to receive the DUT 50 in a commercial embodiment of the motherboard 78. This footprint 79 includes a plurality of electrical interconnects 80, also known as pads, that are aligned to receive solder balls, leads or contacts 82 that extend from the bottom surface 84 of the PCB adapter 68. In one arrangement, the electrical interconnects or pads 70 of the PCB adapter 68 are designed to replicate the electrical interconnects or pads 80 of the footprint 79 of motherboard 78. In this arrangement, the PCB adapter 68 is merely a pass-through.

In another arrangement, the electrical interconnects or pads 70 of the PCB adapter 68 are different from the electrical interconnects or pads 80 of the footprint 79 of motherboard 78. Rerouting the electrical interconnects or pads 70 of the PCB adapter 68 allows the user to test different DUTs 50. In addition additional components or functionality can be placed in the PCB adapter. This allows the signals, powers, grounds and/or traces to be rerouted. In addition, this allows improved or different DUTs 50 to be tested. This also allows the user to test DUTs 50 with different footprints on the motherboard 78. In addition, the modified PCB adapter 68 can provide various test-points for further testing purposes.

In one arrangement, the solder balls, leads or contacts 82 shown on the bottom surface 84 of the PC adapter 68 are electrically connected to the electrical interconnects 70 shown on the top surface of the PC adapter 68. In one arrangement BGA is used to connect the PCB adapter 68 to the motherboard 78. Alternatively the adapter 68 is soldered to the motherboard 78 and/or any other method or means of connecting the PCB adapter 68 to the motherboard 78 is used.

To assemble the system 10, the pusher block 34 is positioned within sidewalls 16 of the housing 12 such that opening 32 of block 34 aligns with opening 18 of housing 12. Pusher screw 30 is inserted through opening 18 and into opening 32 such that ridge 46 is received within groove 48 of pusher block 34.

DUT 50 is placed on top of contact set 56 and aligned such that the downwardly extending leads 54 of the DUT 50 are positioned over and engage the electrical interconnects 66 on the top surface of the contact set 56. Once aligned, the frame 57A is aligned with and held within the slot 28 in the bottom edge 20 of the housing 12. In this position, the dowels 24 of housing 12 are received in slots 60 of tabs 58 assuring proper alignment and hold.

The PCB adapter 68 is connected to the motherboard 78. This is accomplished by either starting with a motherboard 78 that does not include a chip or packaged integrated circuit connected to footprint 79; or alternatively, if a chip or packaged integrated circuit is connected to footprint 79 by removing the chip or packaged integrated circuit. The chip or packaged integrated circuit may be removed by any conventional means such as melting the solder that connects the chip or packaged integrated circuit to the motherboard 78, grinding the chip or packaged integrated circuit off of the motherboard 78, or by any other means or methods. Once the footprint 79 is clear and the electrical interconnects 80 of the footprint 79 are exposed, the PCB adapter 68 is aligned with and connected to the motherboard 78 by any conventional means such as soldering, BGA or the like. This connects the solder balls, lead or electrical contact 82 of the PCB adapter to the electrical interconnects 80 of the footprint 79 of the motherboard 78.

Once the PCB adapter 68 is rigidly, permanently or non-removably connected to the motherboard 78, the housing 12 is then placed on the PCB adapter 68 such that the dowels 24 are received in openings 76 of the PCB adapter 68. In this arrangement, the bottom edge 20 of the housing 12 is connected to or adhered to the mounting surfaces 74 of the PCB adapter 68. In this arrangement the system 10 is then connected to the motherboard 78 for testing.

Once assembled, the screw 30 is rotated or adjusted which moves the pusher block 34 towards and away from the PCB adapter 68. When this movement is towards the PCB adapter 68, the pusher block 34 forces downward on the DUT 50 which forces downward on the contact set 56 which is sandwiched between the pusher block 34/DUT 50 combination and the non-movable PC adapter 68 which is connected to the motherboard 78. This downward motion squeezes or compresses flexible member 57B which is held within rigid frame 57A. This compression causes the plurality of electrical interconnects 66 therein to similarly compress. As the flexible member 57B compresses, the columns of particles of electrically conductive material suspended within the elastomeric interconnect that form electrical interconnects 66 similarly compress thereby forming an electrically conductive column through the flexible member 57B.

By the elastomeric interconnect being flexible, this allows the flexible member 57B and the individual electrical interconnects 66 therein to compensate for variation of coplanarity between the DUT 50 and the PCB adapter. This reduces the number of shorts or connection failures between the downwardly extending leads 54 of the DUT 50 and the electrical interconnects 70 of the PC adapter 68. In addition, the columns of compressible conductive particles provide a high quality electrical connection between the DUT 50 and the PCB adapter 68 which provides excellent electrical performance, high contact area (with more contact points), high bandwidth (˜39˜25 GHz@−1 dB (S21)) minimal solder ball deformation, no load board damage, missing ball detection, fast & easy maintenance, lower cost of ownership, among other improvements and advantages.

In operation, this system can be easily used to test a plurality of different Packaged Integrated Circuits (such as DUT 50) on a motherboard 78 when no mounting or alignment features or test features are positioned on motherboard 78.

In another arrangement, to provide additional strength of connection between PCB adapter 68 and housing 12, conventional screws connect housing 12 to PCB adapter 68. Alternatively, the housing 12 is connected to PCB adapter 68 by adhering, gluing, welding, soldering, snapping, or any other manner or method of connecting or binding two components together. This allows additional pressure to be applied to the DUT 50 without the housing separating from the PCB adapter 68. Accordingly, a test socket system 10 has been disclosed in the art that, at the very least, meets the stated objectives. That is, the system and method described herein improves upon the state of the art; it provide a test socket system that does not require mounting or alignment features on the motherboard; it provides a test socket system that accommodates passive components near active components; it is inexpensive; it is easy to use; it compensates for variation of the coplanarity between the device under test and the motherboard or the PCB adapter; and it has a zero footprint, among other features and advantages.

It will be appreciated by those skilled in the art that other various modifications could be made to the device without parting from the spirit and scope of this invention. All such modifications and changes fall within the scope of the claims and are intended to be covered thereby.

What is claimed:

1. A test socket system, comprising:
a housing;
a pusher block positioned within the housing;
an integrated circuit positioned below the pusher block;
a contact set positioned below the integrated circuit and aligned by the housing; and
a printed circuit board adapter positioned below the contact set;
wherein the pusher block applies pressure to the integrated circuit.

2. The system of claim 1 wherein the housing has side walls with dowels that extend downwardly along a bottom edge of the side walls.

3. The system of claim 1 wherein the printed circuit board adapter is connected to a motherboard.

4. The system of claim 1 wherein the contact set has tabs on its sides that are in vertical alignment with dowels of the housing.

5. The system of claim 1 wherein the contact set is received within the side walls of the housing.

6. The system of claim 1 wherein the printed circuit board adapter has holes that align with and receive dowels of the housing.

7. The system of claim 1 wherein the contact set includes a rigid frame which surrounds a flexible member having a plurality of electrical interconnects.

8. The system of claim 1 wherein the contact set includes a plurality of electrical interconnects which are formed of columns of conductive material held by a flexible member.

9. The system of claim 1 wherein the contact set includes a plurality of columns of suspended gold.

10. The system of claim 1 wherein the contact set includes a flexible silicon rubber having a plurality of columns of conductive material.

11. A test socket system, comprising:
a housing;
a pusher block held by the housing,
the pusher block being vertically adjustable;
an integrated circuit positioned below the pusher block;
a contact set positioned below the integrated circuit;
a printed circuit board adapter positioned below the contact set;
the printed circuit board adapter connected to a motherboard;
wherein the contact set includes a plurality of electrical interconnects which connect the integrated circuit to the printed circuit board adapter.

12. The system of claim 11 wherein the contact set has a flexible material having a plurality of columns of conductive material therein.

13. The system of claim 11 wherein when the pusher block applies pressure to the integrated circuit the contact set creates an electrical connection between integrated circuit and the printed circuit board adapter.

14. The system of claim 11 wherein the electrical interconnects are formed of gold particles.

15. The system of claim 11 wherein the electrical interconnects are formed of particles suspended in a flexible material.

16. The system of claim 11 wherein the electrical interconnects are non-conductive when not compressed, and conductive when compressed.

17. The system of claim 11 wherein the electrical interconnects are held within silicon rubber.

18. A test socket system, comprising:
a housing;
a pusher block held by the housing,
the pusher block being vertically adjustable;
an integrated circuit positioned below the pusher block;
a contact set positioned below the integrated circuit;
the contact set having a flexible material which holds a plurality of electrical interconnects;
a printed circuit board adapter positioned below the contact set;
the printed circuit board adapter connected to a motherboard;
wherein when the pusher block applies pressure to the system, the contact set electrically connects the integrated circuit to the printed circuit board adapter.
